(19) United States
(12) Patent Application Publication
(10) Pub. No.: US 2010/0111624 A1
(43) Pub. Date: May 6, 2010

(54) EXTENDER FOR HOLE SAW AND PIPE INSTALLATION TOOLS AND METHODS

(76) Inventor: BRUCE SEIBOLD, JEROME, ID (US)

Correspondence Address: PEDERSEN & COMPANY, PLLC, P.O. BOX 2666, BOISE, ID, 83701, US

(21) Appl. No.: 12/265,269

(22) Filed: Nov. 5, 2008

(51) Int. Cl. F16L 5/00; B23B 51/04; B23B 51/12

(52) U.S. Cl. 408/1 BD; 408/239 A; 408/239 R; 408/207; 138/103; 52/741.1

(57) ABSTRACT

An extender is used with a hole saw or other cutting or drilling bit to drill/saw a passageway, through thick or distant materials in a residential or commercial building, for installation of a fluid pipe, an electrical conduit, or other conduits or elongated members. The extender and methods of using the extender comprise a hollow pipe with only external threads at each end. After the passageway is created, the externally-threaded pipe may be left in place in the passageway for use in its plumbing capacity. No internal threads are present in the interior surface of the pipe, so that turbulent fluid flow through the pipe is prevented or minimized, and, as a result, pitting, damage, and disintegration of the interior wall of the pipe is prevented or minimized.

### BACKGROUND OF THE INVENTION

1. Field of the Invention

The invention relates to extenders for hole saws or for other cutting tools that are used by plumbers in residential and commercial structures. The extender allows a plumber or other construction worker to provide a passageway through wood or other sawable materials for receiving a pipe. The preferred embodiments comprise an extender that comprises the pipe that the plumber wishes to install in the passageway, and methods that comprise disconnecting the pipe from the saw and power unit and optionally leaving it in place in the passageway for its intended plumbing use.

2. Related Art

Extenders for drilling or sawing at a distance from the user, by means of a hand-held drill power unit, have been developed in the past. For example, the following systems appear in the patent literature: Klein, et al. (U.S. Pat. No. 7,127,972, issued Oct. 31, 2006); DeBlasio (U.S. Pat. No. 6,558,089, issued May 6, 2003); Hanson (U.S. Pat. No. 6,601,478, issued Aug. 5, 2003); Carpinetti (U.S. Pat. No. 5,957,634, issued Sep. 28, 1999); and Carrol (U.S. Pat. No. 5,624,214, issued Apr. 29, 1997); Bowling (U.S. Pat. No. 4,906,146, issued Mar. 6, 1990); Salyers (U.S. Pat. No. 4,474,513, issued Oct. 2, 1984); Emmerich (U.S. Pat. No. 4,206,821, issued Jun. 10, 1980); and Siebrecht (U.S. Pat. No. 4,076,444, issued Feb. 28, 1978).

### SUMMARY OF THE INVENTION

The invention comprises an extender system for use with a hole saw or other hole-forming tool to allow drilling/sawing of holes to create a passageway through multiple or thick pieces of wood or other materials in a residential or commercial building structure. The passageway receives a fluid flow pipe that connects to fittings for other plumbing in the building structure. The extender system and methods of using the extender system comprise a hollow pipe with only external threads at each end. The preferred methods comprise using the extender system to drill through said multiple or thick wood or other materials, then disengaging the externally-threaded pipe from the any apparatus attached to its ends, and optionally leaving said externally-threaded pipe in place in the passageway that was created with the hole-forming tool, for use in its plumbing capacity. The externally-threaded pipe allows said use of the pipe in its plumbing capacity without the internal threads or other disruptions in the interior surface that typically cause turbulent fluid flow through the pipe and, as a result, the invented system reduces or prevents turbulence-caused pitting, damage, and disintegration of the interior, and, ultimately the entire wall, of the pipe.

### BRIEF DESCRIPTION OF THE DRAWINGS

FIG. 1A portrays one embodiment of the invented extender system in use with a power unit and a hole saw bit, during drilling/sawing through multiple, spaced pieces of wood.

FIG. 1B portrays the externally-threaded pipe that is part of the extender system in FIG. 1A, disconnected from the hole saw, the power unit, and the other portions of the extender system, and left in place in the passageway drilled/sawn through the pieces of wood.

FIG. 2 is a perspective view of the extender system of FIG. 1A, with hole saw attached, wherein the externally-threaded pipe is cut in two (and a substantial length of the pipe not shown) for ease of illustration of the opposing ends of the extender system.

FIG. 3 is a side view of the extender system, attached to a hole saw bit, of FIGS. 1A and 2.

FIG. 4 is a side view of the saw end of the system of FIGS. 1A, 2, and 3, with the pipe connection region shown in cross-section.

FIG. 5 is a side view of the power unit end of the system of FIGS. 1A 2-4, partially shown in cross-section.

### DETAILED DESCRIPTION OF PREFERRED EMBODIMENTS

Referring to the Figures, there are shown two, but not the only, embodiments, of the invented extender system for drilling/sawing a passageway for a pipe intended for conducting fluids through a building. There is also shown in the Figures, one embodiment of a method for forming a passageway and installing an externally-threaded pipe in said passageway by using an externally-threaded standard fluid plumbing pipe as a portion of the extender system. The preferred forming and installing methods minimize the number of steps and apparatus that must be used to accomplish the plumbing task. While the preferred embodiment is described and drawn as including a hole saw, other cutting or drilling tools may be connected to the distal end of the extender system, for example, any auger-style or self-feeding bits, and/or a spade bit or other drill bit that makes a large hole. Said cutting or drilling tools preferably are selected from those that are capable of making a hole in the range of 1-6 inches. The term “hole-forming tool,” therefore, may be used to include a hole saw, spade bit, and/or other tools that may be installed at the distal end of the extender system for the methods described herein.

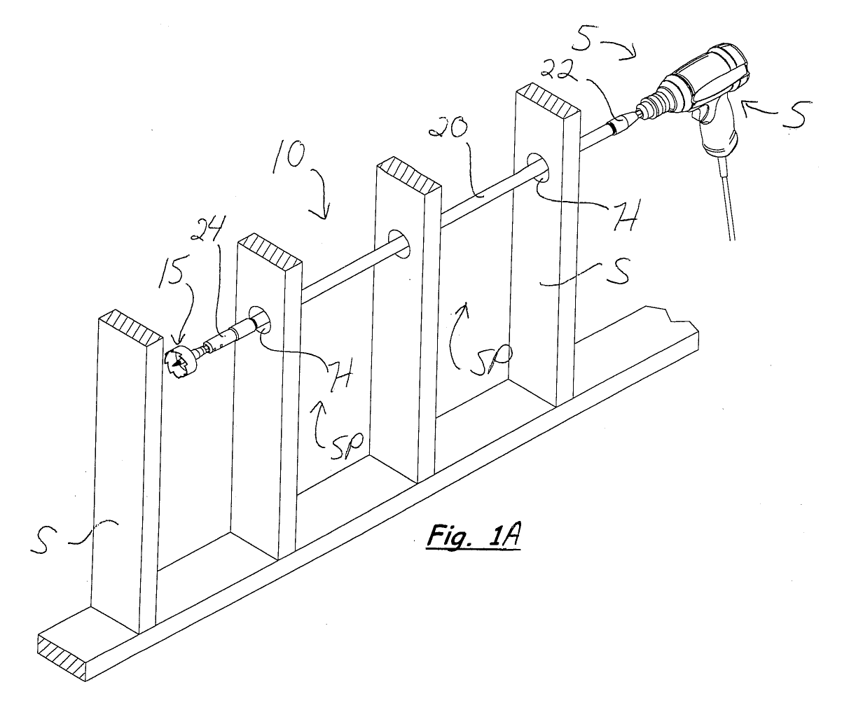

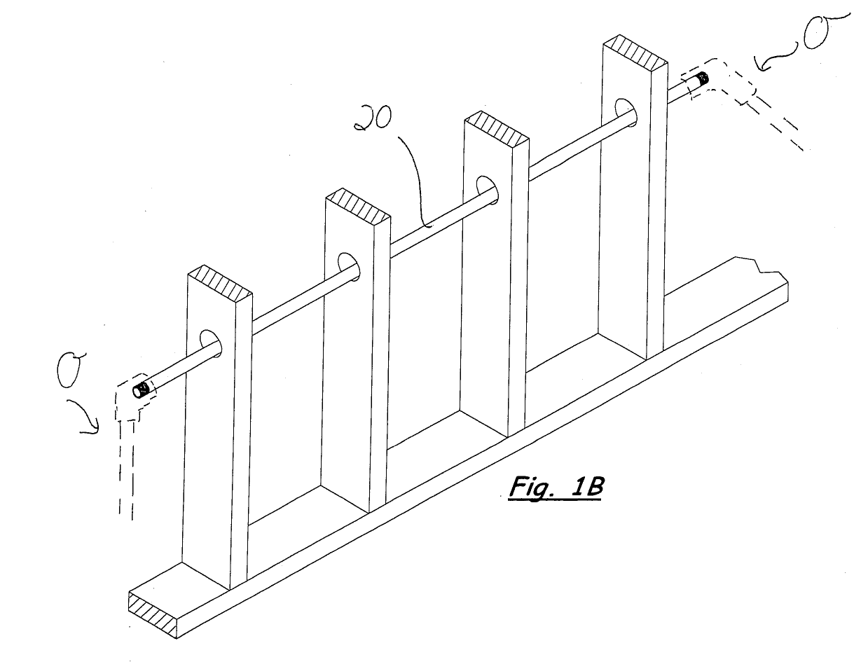

FIG. 1A portrays the preferred embodiment in use sawing through multiple, spaced-apart pieces of wood. In this portrayal, the wood pieces are studs S of a wood frame wall W, and the sawing is done in a horizontal direction to create a passageway comprising holes H in the studs and the spaces SP between the studs. A power unit 5 is connected to a proximal end of the preferred extender system 10, and a hole saw 15 is connected to a distal end of the preferred extender system 10.

The extender system 10 is portrayed in FIG. 1A to be several feet long, so that it extends through and between several studs S. The extender system 10 may be of various lengths, but is typically in the range of 6 inches-21 feet long, as it is preferably used to reach 3-10 feet from the user, for example, through walls, from basements up through a floor and into the interior of a wall, and/or through a ceiling/floor- between floors of a multiple-story building. Longer extender systems may be possible, but may require more than a conventional hand-held power unit. The preferred embodiment is especially useful for drilling/sawing through structure into which the user cannot reach and/or see easily and through which a long, straight hole/passage must be formed. For example, such long, straight holes/passages may be required for plumbing, for electrical conduit, for various flexible electrical cables, or other elongated elements. The rigid, elongated extender system allows the user to begin the drilling/sawing in an area of relative comfort and room and to continue drilling/sawing “blind” through distant areas.

The preferred embodiments allow the drilling/sawing of the passageway to be done straight and accurately, and the pipe, which is coaxial with the passageway as it is created, remains coaxial with the passageway during use. The pipe 20 is symmetric about its axis, as are, preferably, the bit connector 22 and the saw connector 24, in order to prevent wobbling and/or inaccurate cutting/sawing.

Upon completion of the passageway for plumbing applications, the user and/or assistant(s) may optionally disconnect the pipe 20 of the extender system 10 from the bit connection unit 22 (or “bit connector”), and from the saw connection unit 24 (or “saw connector”), to leave only the pipe 20 remaining in the passageway. The bit connector 22 and the saw connector 24 are removed by unscrewing them from the pipe 20, and no fasteners, screws, set screws, or other fasteners (other than the threads) need be disconnected in order to disconnect the pipe 20 from this adjacent apparatus. No tools are needed to accomplish the disconnection except perhaps for a pipe wrench or other wrench/pliers to grip and turn the bit connector 22/pipe 20 relative to each other, and to grip and turn the saw connector 24/pipe 20 relative to each other. Thus, as best shown in FIG. 1B, the pipe may be left in the intended position, installed properly for connection to other plumbing O for subsequent use. Note that, the pipe 20 is left in place, undamaged and unmarred, as no fasteners or connection means were used (other than the pipe threads) during its being connected and used as a drill/saw extender.

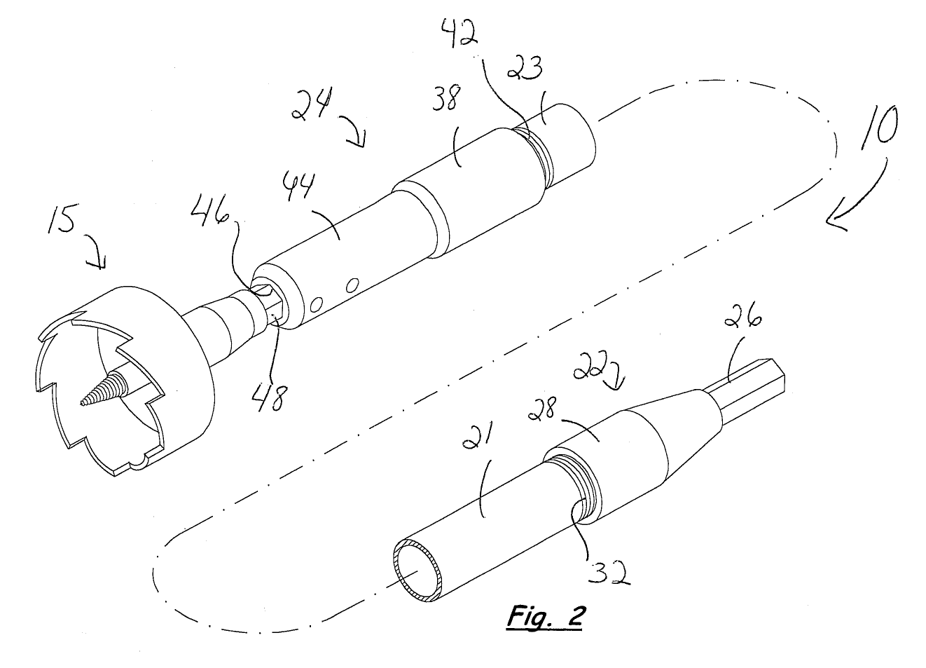

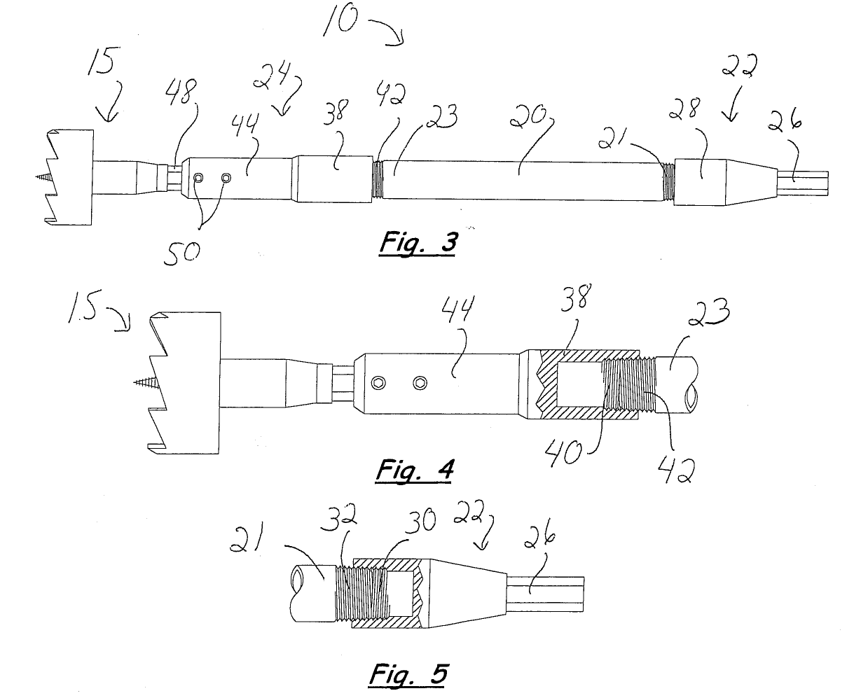

Details of the preferred embodiment are shown to best advantage in FIGS. 2-5. Extender system 10 comprises externally-threaded pipe 20, bit unit 22, and saw connection unit 24.

The bit connector 22 has a bit end 26, with a hexagonal exterior surface, for being received and locked into the power unit 5, and an opposing female end 28 for threadably connecting to the proximal end 21 of the pipe 20. Preferably, no screws, set screws, or other fasteners are used to connect the pipe 20 to the bit connector 22. The female end 28 has internal threads 30 for connecting to the external threads 32 of the proximal end 21 of pipe 20 (see FIG. 5). Pipe 20, as discussed above, preferably extends for several feet to reach, and to allow cutting (drilling/sawing), entirely through the passageway with one length of pipe, that is, preferably only a single pipe is needed rather than multiple pipes connected together. Therefore, there are preferably no significant discontinuities in the internal surface of the pipe portion of the extender system 10 because the pipe portion is a single, continuous pipe length.

The saw connector 24 has a proximal female end 38 with internal threads 40 that connect to the external threads 42 of the distal end 23 of the pipe 20 (see FIG. 4). Preferably, no screws, set screws, or other fasteners are used to connect the pipe 20 to the saw connector 24. The distal end 44 of the saw connector 24 preferably has a female hexagonal interior surface 46 for mating with the hexagonal exterior surface of bit end 48 of the hole saw 15. One or more set screws 50 extend from the outside of distal end 44 through holes in the wall of the distal end 44, for being screwed inward to abut against, and lock, the bit end 48 of the hole saw that is received inside the distal end 44. Preferably, two of said screws 50 are spaced from each other and lie in an axial line on an axial surface of distal end 44. Alternatively, other mechanical fasteners may be used to secure the bit end 48 of the hole saw 15 into the saw connector 24, however, compact and light-weight fasteners are preferred so that the weight of the extender system 10 remains generally symmetric around the central axis of the extender system 10.

Alternatively, the extender system may have different bit styles, including different bit exterior surface shapes. For example, the bit end 26 of the bit connector 22 may be other polygonal shapes besides hexagonal, may be cylindrical, or may be any shape or style required for adaptation to alternative power units. The bit end 48 of the saw connector 24 also may be other polygonal shapes besides hexagonal, may be cylindrical, or may be any shape or style required for adaptation to alternative power units, and/or any shape or style for adaptation to the female, distal end 44 of the saw connector. For example, bit end 26 may be one shape/style to cooperate with a particular power unit, while the bit end 48 of the hole saw may be another shape/style to cooperate with a particular saw connector 24, and the bit ends 26, 48, therefore, do not necessarily need to be the same shape/style. Good gripping features, such as a polygonal shape are preferred, however, to provide secure and reliable connections during sawing. Note also, that keyed, keyless, or other types of chucks and/or power units may be used.

It may be noted that the simple and durable construction of the preferred extender system 10, and particularly the externally-threaded pipe 20 therein, provides for efficient creation of a passageway for a fluid pipe or for other elements of a building, particularly where at least a portion of the passageway is at a hard-to-reach distance or position relative to the person creating the passageway. In plumbing applications, the preferred extender system 10 allows efficient installation of said pipe in a minimum number of steps, because the pipe element of the extender may be left in place as the pipe for that section of plumbing. In such plumbing applications, a substantial portion of the extender system need not be removed from the holes and spaces through which the drilling/sawing has been done, but instead left there for the ultimate purpose of the project, that is, to have a fluid pipe extend through those holes/spaces for subsequent use when the building is completed/occupied.

The above methods may all be accomplished with a pipe that is optimum for said subsequent use, by virtue of having only external threads (no internal threads), preferably external National Pipe Threads (according to U.S. NPT threaded pipe standards). The external threading provides superior surfaces for fluid flow, by maintaining a non-threaded internal surface inside the pipe that is smooth except for any natural texture or irregularities of the pipe metal, which natural texture or irregularities would be insignificant compared to the roughness created by threads. The externally-threaded pipe interior surface does not cause, or at least does not increase, turbulence in the fluid flow and consequent pitting and damage of the pipe wall, and, hence significantly extends the life of the pipe in its use as a fluid conduit.

The preferred pipe 20 may be any type of metal pipe, typically ½ inch or ¾ inch diameter, with normal iron pipe size (IPS) thread. A ½ inch pipe is expected to be usable with any size drill bit without bending or striping the threads. Most preferably, black iron or galvanized schedule 40 or 80 pipe is used as pipe 20.

In preferred embodiments, therefore, the extender system comprises a bit connector 22 with both a male bit and a female threaded receptacle, and a saw connector 24 with two female ends, one with threads and one with a polygonal or other surface that mates with the hole-forming tool to discourage relative rotation. The saw connector 24 may include set screws to discourage axial movement of the hole-forming tool relative to the saw connector 24. Each of the bit connector 22 and the saw connector 24 will typically be about 3-8 inches long (and more preferably 4-6 inches long). The bit connector 22 and the saw connector 24 may be adapted for use with a keyed chuck on a conventional power unit 5 such as a Jacobs™ power unit that has, for example, a ⅜ or ½ inch chuck. Alternatively, may be adapted for use with a keyless chuck on a conventional power unit such as a Dewalt™ power unit, for example.

The pipe 20 is preferably is a single, continuous piece of pipe having a length in the range of 0.5-21 feet long, depending upon the application and user preference, wherein the bit connector 22 is preferably a single unitary piece with no disconnectable parts, and the saw connector is preferably a single unitary piece with two set screws as its only disconnectable parts. For many applications, a continuous piece of pipe in the range of 3-10 feet long will be effective, but special applications may find a shorter or longer pipe beneficial. All of said pipe, bit connector, and saw connector are preferably all metal.

Although this invention has been described above with reference to particular means, materials and embodiments, it is to be understood that the invention is not limited to these disclosed particulars, but extends instead to all equivalents within the scope of the following claims.

I claim:

1. An extender system for installing a fluid pipe in a building, said system comprising:
a pipe with a proximal end that is threaded only externally and a distal end that is threaded only externally;
a bit connector having a female, threaded end that receives ands threadably connects to said externally-threaded proximal end of the pipe, and having an opposing, male end for being connected to and driven by a power unit;
a saw connector having a female, internally-threaded proximal end that receives and threadably connects to said externally-threaded distal end of the pipe, the saw connector having an opposing, female distal end;
a hole-forming tool with a bit end that is received in and locked in said opposing female distal end of the saw connector so that the hole-forming tool is driven to form a passageway through multiple layers or pieces of wood, wherein the passageway is coaxial with said pipe and said pipe, when left in the passageway and disconnected from the bit connector and the saw connector, is connectable to other plumbing in said building for use as a fluid pipe, and wherein said pipe has no internal threading so that fluid turbulence is minimized or prevented.

2. An extender system as in claim 1, wherein the hole-forming tool bit end and the saw connector distal end have mating polygonal exterior surfaces.

3. An extender system as in claim 1, wherein the bit connector male end has a polygonal outer surface for securement in a power unit drill chuck.

4. An extender system as in claim 3, further comprising at least one set screw extending from the saw connector to engage said bit end of the hole saw.

5. An extender system as in claim 4, comprising no screws and no set screws extending from the saw connector to contact said pipe.

6. An extender system as in claim 5 that comprises no screws and no set screws contacting said pipe when the pipe is connected to the bit connector and to the saw connector.

7. An extender system as in claim 6, wherein said pipe is a single, continuous piece of pipe having a length of 0.5-21 feet long.

8. An extender system as in claim 6, wherein all of said pipe, bit connector, and saw connector are metal.

9. An extender system as in claim 6, wherein the hole-forming tool comprises a hole saw.

10. An extender system as in claim 8, wherein the pipe is selected from the group consisting of: black iron pipe, galvanized pipe, schedule 40 pipe, and schedule 80 pipe.

11. An extender system for installing a pipe or conduit in a building, said system consisting of:
a pipe with a proximal end that is threaded only externally and a distal end that is threaded only externally, so that the only threads at any location on said pipe are external;
a bit connector having a female, threaded end that receives ands threadably connects to said externally-threaded proximal end of the pipe, and having an opposing, male end for being connected to and driven by a power unit;
a saw connector having a female, internally-threaded proximal end that receives and threadably connects to said externally-threaded distal end of the pipe, the saw connector having an opposing, female distal end;
a hole-forming tool with a bit end that is received in and locked in said opposing female distal end of the saw connector so that the hole-forming tool is driven to form a passageway through multiple layers or pieces of wood, wherein the passageway is coaxial with said pipe.

12. A method of installing a fluid pipe in a building, the method comprising:
providing a hand-held drill power unit
providing an extender system and a hole-forming tool, and securing said extender system to the power unit and to the hole-forming tool;
the extender system comprising a hollow pipe having external threads on each end and no internal threads, a bit connector that threadably attaches to the external threads of a proximal end of the pipe and that is received into a chuck of the power unit, and a saw connector that threadably attaches to the external threads of the distal end of the pipe and that receives and is locked to the hole-forming tool;
sawing through multiple pieces or layers of wood to form a passageway through the wood by rotating the extender system with the power unit, which rotates the hole-forming tool;
detaching the bit connector from the pipe and detaching the saw connector from the pipe and leaving the pipe in the passageway;
connecting the pipe left in the passageway to other plumbing in the building by threadable connection of the external threads of the proximal end and of the distal end of the pipe; and
using said pipe left in the passageway for fluid flow.

13. A method as in claim 12, wherein connection of the pipe to the bit connector and to the saw connector comprises only said threadable attachment and comprises no screws and no set screws.

14. A method as in claim 12, wherein the pipe comprises no internal threads at any position along its entire length.

15. A method as in claim 12, wherein the hole-forming tool is a hole saw that comprises a circular ring portion with a sharp distal edge, a central drill portion extending through the ring portion on the central axis of the ring portion, and a bit end extending proximally and being received in the saw connector.

16. A method as in claim 12, wherein the pipe has a length in the range of 0.5-21 feet.

17. A method as in claim 12, wherein the pipe is not removed from the passageway between being used for forming the passageway and being connected to said other plumbing of the building.

18. A method as in claim 12, wherein said bit connector comprises a polygonal bit end that is secured into the chuck of the power unit, the hole-forming tool has a bit end comprising a polygonal exterior surface, and the saw connector has a female distal end with a polygonal interior surface for mating with the polygonal exterior surface of bit end of the hole-forming tool.

19. A method as in claim 18, further comprising tightening two set screws extending from the saw connector to engage said polygonal exterior surface of the bit end of the hole-forming tool, and wherein no screws or set screws are used to connect the pipe to the bit connector and no screws or set screws are used to connect the pipe to the saw connector.

20. A method as in claim 19, wherein all of said pipe, bit connector, and saw connector are metal.
